(19) United States
(12) Patent Application Publication
(10) Pub. No.: US 2009/0304235 A1
(43) Pub. Date: Dec. 10, 2009

(54) METHOD AND DEVICE FOR OBSERVING AN OBJECT

(76) Inventors: Claude Amra, Marseille (FR); Carole Deumie, Plan de Cuques (FR); Frederic Chazallet, Marseille (FR)

Correspondence Address: JEROME D. JACKSON (JACKSON PATENT LAW OFFICE), 211 N. UNION STREET, SUITE 100, ALEXANDRIA, VA, 22314, US

(21) Appl. No.: 12/158,760

(22) PCT Filed: Dec. 19, 2006
(86) PCT No.: PCT/FR2006/002777

§ 371 Date: Mar. 4, 2009

(30) Foreign Application Priority Data
Dec. 23, 2005 (FR) 0513300

(51) Int. Cl. G06K 9/46

(52) U.S. Cl. 382/106; 250/225; 250/221; 250/559.07

(57) ABSTRACT

The invention relates to a method of analysing or observing an object (40) along an observation direction (θ, φ), characterized in that:—a substantially monochromatic incident electromagnetic wave in the form of a polarized plane wave (E⁺) is directed towards the object,—an image of the object is captured, said image possibly being a point image, resulting from the electromagnetic wave (A(θ, φ)) that may be specular, scattered or diffracted by at least one interface or a volume of the object illuminated by the incident wave, in the observation direction,—a retarder (43) with adjustable retardation and an analyser (44) whose orientation is adjustable are disposed in succession in the path of the wave (A(θ, φ)), between an imaging sensor (45) and the object observed,—the retardation (Δη*(θ, φ)) of the retarder and the orientation (ψ(θ, φ)) of the analyser are adjusted so as to minimize—or even cancel—a part g(A) of the wave (A(θ, φ)) filtered by the retarder and the analyser.

The present invention relates to a method of observation of an object and to a device for the implementation of this method.

The present invention relates to observation techniques for objects subject to (“illumination” by) electromagnetic waves, particularly to waves having wave lengths corresponding to spectra from X-ray to microwaves. The applications of the invention relate, in particular, to optics, microelectronics, remote sensing, bio-photonics, biomedical, or imagery in hostile or scattering environments.

Electromagnetic sounding enables remote examination (without contact), and in a non-destructive manner, of different types of objects or collections of objects, random or deterministic, microscopic or macroscopic. This technique is employed, for example, to digitize optoelectronic scenes or examine oceans in the radio domain.

Certain sounding techniques use direct specular light to produce imagery (microscope). Various new microscopies (confocales, non-linear, tomography) have recently been proposed. When direct light is unavailable, secondary or scattered light can be used apart from the specular directions, to examine the studied objects. In this case, an image of the object observed is generally not reconstructed, but characteristic signals of the object, even statistical moments, are accessed.

The effectiveness of these techniques is often limited by the presence of a specular or scattered parasitic light. In some cases this unwanted light entirely masks the signal or image, and it would be entirely advantageous to eliminate it. An object of the invention is to offer a method and a device enabling attainment of this result.

The invention relates particularly to a method and device for observation of an object wherein a substantially monochromatic incident electromagnetic incident flux (IF), in the form of a polarized plane wave, is emitted and directed toward the object.

The patents U.S. Pat. No. 6,034,776 and U.S. Pat. No. 6,924,893 describe techniques of this kind.

In accordance with an aspect of the invention, a method of analysis and/or observation of an object along an observation direction (θ, φ) is proposed, wherein:

a substantially monochromatic incident electromagnetic wave in the form of a polarized plane wave (E⁺) is directed toward the object,

an image of the object, possibly a point image, is captured, the image resulting from the electromagnetic wave (A(θ, φ)) specular, scattered, or diffracted by at least an interface or a volume of the object illuminated by the incident wave in the observation direction (θ, φ),

a retarder, having adjustable delay, and an analyzer, whose orientation (in a plane perpendicular to the path of the flux (A (θ, φ))) is adjustable, are successively arranged on the path of the wave (A (θ, φ)), between a sensor (of imagery) and the observed object,

the delay (Δη*(θ, φ)) of the retarder and the orientation (ψ (θ, φ)) of the analyzer are adjusted to minimize—even cancel—a part g (A) of the wave (A (θ, φ)) filtered by the retarder and the analyzer.

According to preferred implementation modes:

the retarder includes a transparent medium (amorphous or crystalline solid or fluid) whose refractive index (and the resulting delay) is modified by applying an electric field, a magnetic field, an electromagnetic wave, or a mechanical stress;

the retarder includes a Pokels cell, a Kerr cell, or liquid crystals;

the retarder includes two parallel half-wave plates whose mutual orientation (and the resulting delay) is adjustable;

one or more value (s) of the delay and one or more values of the orientation of the analyser, for which a part g(A) of the wave (A (θ, φ))) is minimized or cancelled, are estimated according to a model of the object; preferably still this model includes (and/or is based on) geometric data relating to interfaces and/or volume(s) of the object, values of roughness of interfaces of the object, and values of refractive index of the media constituting and surrounding the object;

notably when the structure and properties of the object are unknown, a range of values of delay can be sweeped and for each value of this range a range of values of orientation is sweeped, and the intensity of the flux received by all or part of the sensor for each value pair of delay and orientation, then one or more of these value pairs of delay and orientation for which the intensity—or another characteristic of—this flux is minimum; in this case particularly, a merit function such as a measure of the high-frequencies (spatial) of the image can be used, to seek the value pair(s) of delay and orientation for which this function is maximum; with a maximum of high-frequencies corresponding to a minimum interference and/or a maximum contrast of the image obtained.

the angles of incidence of illumination and the angle of polarization of the incident flux and the angles (θ, φ) of the observation direction are chosen so that the first values of delay and of orientation corresponding to the minimization of the first (undesirable) part of the wave (A (θ, φ)) are moved away from second values of delay and of orientation corresponding to the minimization of a second (useful) part of flux (A (θ, φ)). These choices can be based on models of the phenomenon thus enabling calculation of the various parameters.

When the object includes a stack of thin layers, the invention particularly enables capturing an image of an interface separating two thin layers or capturing the image of a sub-stack.

The invention also enables observation of an object immersed in a scattering medium.

According to a particular implementation mode, the wavelength (central) of the incident flux is situated in a range from 250 nm to 15 μm, more particularly 400 to 1100 nanometers.

According to another aspect of the invention, there is proposed a device useful for the implementation of a method defined and described herewith, the device including, to this end:

a substantially monochromatic light source and a polarizer arranged in order to direct an incident flux in the form of a polarized plane wave (E⁺) toward an object,

a sensor sensitive to at least a part g (A) of the wave (A (θ, φ))) specular, scattered or diffracted by at least an interface or a volume of the object illuminated by the incident flux, in an observation direction (θ, φ),

an adjustable retarder and adjustable analyzer successively arranged on the path of the flux (A (θ, φ)), between the sensor and object,

a control unit arranged to control a variation in the delay produced by the retarder and to control a variation in the orientation of the analyzer and enabling minimization or cancellation of a part g (A) of the wave (A (θ, φ)).

According to another aspect of the invention, there is proposed a program including a code useable by a computer apparatus for analysis of an object having at least a volume bounded by at least two interfaces, by the measurement of the electromagnetic flux (A (θ, φ)) specular, scattered, or diffracted by the object illuminated by a polarized plane wave, in an observation direction (θ, φ), wherein the code enables control of an adjustable retarder and an adjustable analyzer arranged in this order on the path of the wave (A (θ, φ)) between a sensor (of imagery) and the object, to enable minimization—even cancellation—of a part g (A) of the wave (A (θ, φ)) scattered, diffracted, reflected or transmitted by at least an interface or a volume of the object, in the observation direction.

According to another aspect of the invention, there is proposed a program including a code useable by a processor of a measuring or observation device for an object illuminated by a polarized plane wave. The code enables implementation of a method in accordance with the invention.

Other aspects, features, and advantages of the invention appear in the following description, which refers to the annexed drawings and which shows, without any limitation, the preferred modes of carrying out the invention.

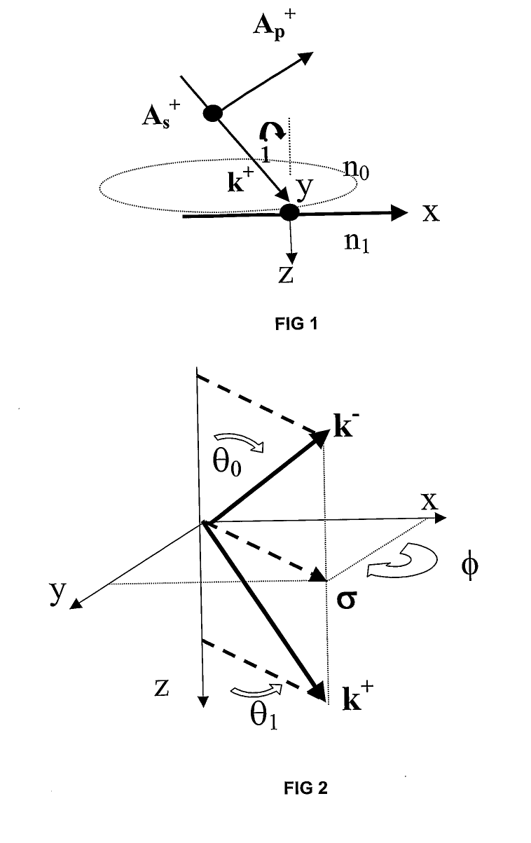

FIG. 1 shows the notations used in regard to the incident polarized wave that strikes a sample 40 having normal z.

FIG. 2 shows the notations of the wave vectors scattered in the observation direction defined by two angles θ and φ.

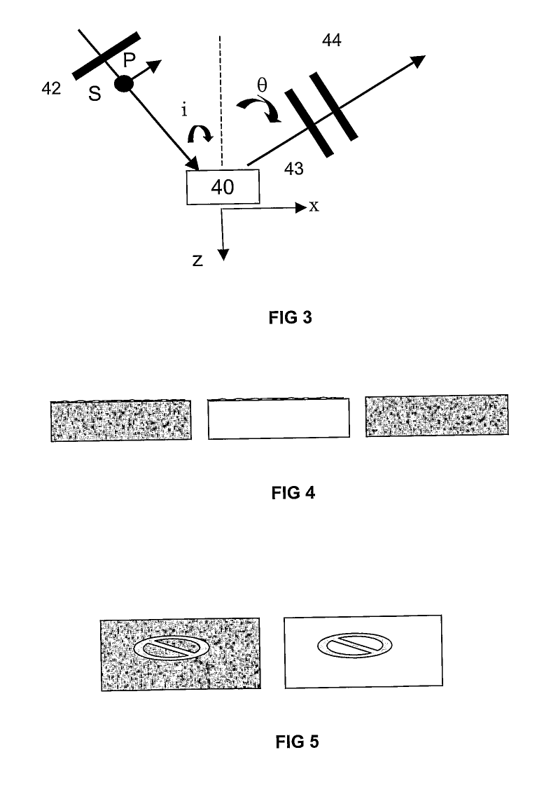

FIG. 3 shows a device according to the invention including an electromagnetic filter implemented with the aid of a retarder and an analyzer.

FIG. 4 shows an operating mode of the invention that includes, starting from a sample having a surface and volume scattering (left rectangle), canceling the volume scattering (center rectangle) and then the surface scattering (right rectangle).

FIG. 5 shows another operating mode of the invention that includes eliminating the volume scattering masking an object thereby revealed.

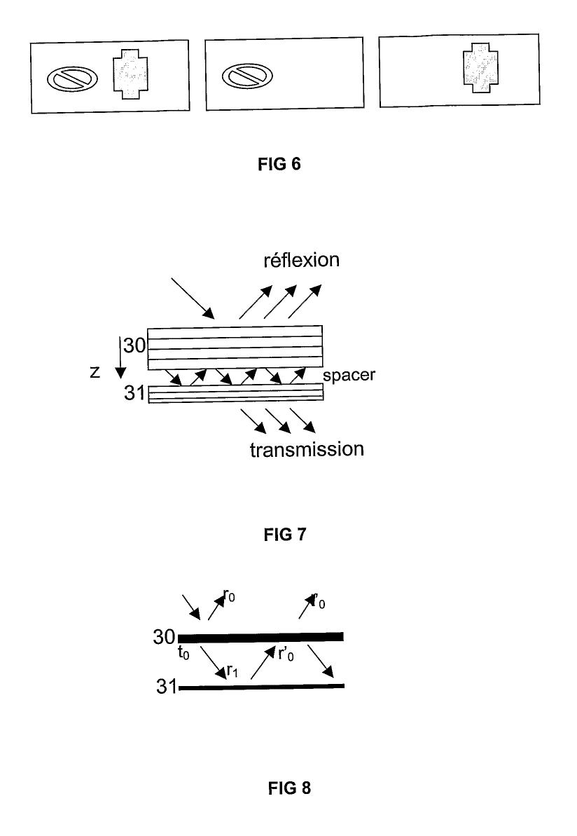

FIG. 6 shows another operating mode of the invention that includes, starting from a sample containing two objects (left rectangle), selecting a single one of two objects (center and right rectangles).

FIG. 7 shows a multilayer stack in wherein a thin layer is arbitrarily chosen to play the role of “spacer”. This layer enables definition of 2 upper (30) and lower (31) substacks.

FIG. 8 shows, starting from the separation introduced in FIG. 7, the reflection and transmission factors defined for the progressive wave by (r0, t0, r1) and for retrograde waves by (r′0, t′0).

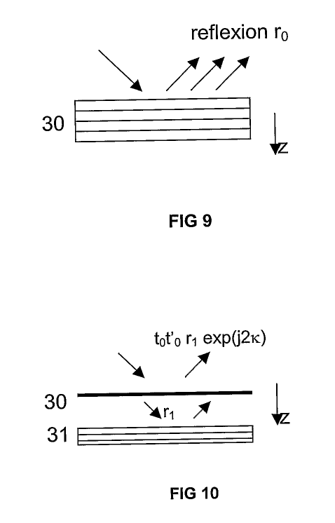

FIG. 9 show that the invention enables acquisition of a reflection similar to a reflection emitted only from the upper part of the stack, enabling examination of the substack.

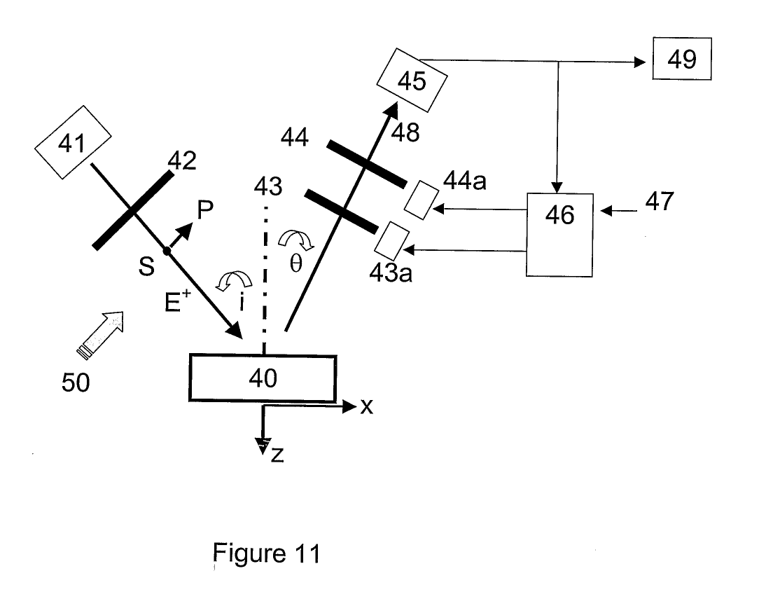

FIG. 10 shows the case where the sounding impacts the lower substack.

One of the aspects of the invention includes cancelling the parasitic light with the aid of a set of destructive interferences between polarization Eigenstates.

In order for this cancellation to occur, the object or 40 sample is illuminated by a polarized light (FIGS. 1 and 3).

The incident plane and polarized wave is written as follows:

E⁺=E_{S}⁺+E_{P}⁺=(A_{S}⁺+A_{P}⁺)expo(j k⁺.p) (1)

where E⁺ represents the electric field vector, E_{S}⁺+ and E_{P} being the polarization modes: S polarization or transverse electric, or P polarization or transverse magnetic. The spatial coordinate is written p=(x, y, z), and the incident wave vector is:

k⁺=k0(sin(i), 0, cos(i)) (2)

with i the angle of incidence on the sample, λ the wavelength, kₒ=2πn₀/λ, n₀ and n₁ the refractive indices of two media (superstrate and substrate) or volumes of the object separated by an interface.

The components A_{S}⁺ and A_{P}⁺ are complex vectors, the algebraic projections of which can be written as:

A_{S}⁺=|A_{S}⁺|exp(jη_{S}) (3-a)

A_{P}⁺=|A_{P}⁺|exp(jη_{P}) (3-b)

The phase terms (η_{S} or η_{P}) are characteristic of the polarization state of the incident wave, which may be elliptical (η_{S}≠η_{P}) or linear (η_{S}=η_{P}) . . . .

In response to the incident wave and according to the nature of the sample (plane, periodic, or random . . . ), a specular, diffracted or scattered electromagnetic field is established. In all cases, and because the incident wave is plane and monochromatic, a detector can far-field measure a determined polarization wave. In a spatial direction (θ, φ), this wave will be written (FIG. 2):

E_{SS}^{±}(θ,φ)=A_{SS}^{±}(θ,φ)exp(j k^{±}.p) (4-a)

E_{SP}^{±}(θ,φ)=A_{SP}^{±}(θ,φ)exp(j k^{±.}p) (4-b)

E_{PS}^{±}(θ,φ)=A_{PS}^{±}(θ,φ)exp(j k^{±}.p) (4-c)

E_{PP}^{±}(θ,φ)=A_{PP}^{±}(θ,φ)exp(j k^{±}.p) (4-d)

Where the signs (−) and (+) represent a retrograde (reflection) or progressive (transmission) wave, and k^{±} the scattered wave vector:

k^{±}=k(sin θ cos φ, sin θ sin φ, ± cos θ) (4-e)

with k=2πn₀/λ (back scattering) where k=2π n₁/λ (transmission scattering).

The indices _{XY} represent polarization _{Y} of the scattered wave, produced by the polarization _{X} of the incident wave:

A_{SS} (θ, φ)) is the component of S polarization in the (θ, φ) direction from the component of S polarization of the initial flux,

A_{SP} (θ, φ)) is the component of P polarization in the (θ, φ) direction from the component of S polarization of the initial flux,

A_{PS} (θ, φ) is the component of S polarization in the (θ, φ) direction from the component of P polarization of the initial flux,

A_{PP} (θ, φ) is the component of P polarization in the (θ, φ) direction from the component of P polarization of the initial flux.

The polarization changes may be more or less rapid with the direction (θ, φ), and more or less significant depending on the nature of the sample (roughness size, heterogeneity contrast . . . ).

In the observation direction (θ, φ), an analyzer is positioned in order to project the polarization components to establish an interferential state. The resulting field is written, in accordance with (4-a)-(4-e):

A(θ, φ)=cos [ψ(θ, φ)][A_{SS}(θ,φ)+A_{PS}(θ, φ)]+sin [ψ(θ, φ)][A_{PP}(θ,φ)+A_{SP}(θ, φ)] (5)

where ψ (θ, φ) represents the angular position of the analyzer for the (θ, φ) direction, relative to the TE or S component of the scattered wave.

Each term of the relation (5) depends on the scattering direction, but also the nature of the sample (optical properties and microstructure).

We can then examine whether the angle ψ (θ, φ) of the analyzer can be positioned to obtain a cancellation of the wave in the ψ (θ, φ) direction, i.e.:

A(θ,φ)=0=>tgψ(θ,φ)=−[A_{SS}(θ,φ)+A_{PS}(θ,φ)]/[A_{PP}(θ,φ)+A_{SP}(θ,φ)] (6)

The second member being a complex number, in (6) it is necessary to be able to simultaneously satisfy a modulus condition and a phase condition. To this end, in addition to the degree of freedom given by the choice of tgψ, a phase shifter or adjustable retarder is introduced (FIG. 3) in the (θ, φ) direction, on the path of the scattered wave. A Pockels type cell, for example, or any other equivalent device is used.

Under these conditions the components of TE or S polarization (respectively TM or P) of the electromagnetic field are multiplied by exp [jη_{S}*] (respectively exp [jη_{P}*]), so that the cancellation condition (6) is transformed as:

tgψ(θ,φ)=−exp [jΔη*(θ,φ)][A_{SS}(θ,φ)+A_{PS}(θ,φ)]/[A_{PP}(θ,φ)+A_{SP}(θ,φ)] (7)

with: Δη*(θ,φ)=η_{S}*−η_{P}*

By means of this adjustable phase term Δη*(θ, φ) in the (θ, φ) direction we can simultaneously satisfy a condition in modulus and intensity:

tg(ψ)=I [A_{SS}(θ,φ)+A_{PS}(θ,φ)]/[A_{PP}(θ,φ)+A_{SP}(θ,φ)] I (8-a)

Δη*=π−Arg{[A_{SS}(θ,φ)+A_{PS}(θφ)]/[A_{PP}(θ,φ)+A_{SP}(θ,φ)]} (8-b)

The relations (8-a)-(8-b) show that it is possible to adjust the orientation of the analyzer (by the choice of the angle ψ) and the delay introduced by the retarder (by the choice of Δη*) to cancel the scattering in the arbitrary direction (θ, φ). This applies to any incident light, specular (reflected or transmitted), diffracted or scattered. In general, the values (ψ, Δη*) vary with the (θ, φ) direction and depend on the nature and form of the sample.

This theoretical cancellation of the flux corresponds physically to a minimization of filtered flux, which generally enables significant increasing of the contrast between the useful part of the received flux and the filtered part.

Thus, the monochromatic light described by a polarized vector field A can be transformed, after feed through by a retarder and an analyzer, as:

A=>f(A)=cos ψ exp(jη_{S}*) [A_{S}+z.A_{P}] (9)

Where z is a complex number given by:

z=tgψ exp(−jΔη*) (10)

with ψ the angle of the pivoting analyzer and Δη* the phase shift introduced by the retarder. The cancellation conditions of this light can then be sought, via the condition:

g(A)=A_{S+}z A_{P}=0 (11)

The cancellation is then obtained in the (θ, φ) direction for the complex _{Z0} given by:

_{Z0}(θ,φ)=−A_{S}(θ,φ)/A_{P}(θ,φ)=tgψ(θ,φ)exp [−jΔη*(θ,φ)] (12)

The transformation g corresponds to an electromagnetic filtering, adjustable using the two parameters ψ and Δη*. This filter enables elimination of specular, diffracted or scattered parasitic light. This cancellation may be selective; in particular this filter enables extinguishing of fluxes masking a useful signal.

With reference to FIG. 3 in particular, the device 50 according to the invention enables analysis and observation of a sample 40. To this end, the sample is illuminated by a plane wave E⁺.

The incident wave is produced by a light source 41 and is polarized by a polarizer 42. The wave—specular (reflected or transmitted), scattered, or diffracted by the sample 20—propagates along a direction 48, through a retarder or phase shifter 43 then an analyzer 44 before being detected and/or measured by a sensor 45.

The sensor 45, which may include a mono-analyzer, a barrette or a matrix of sensors, delivers output signals or image data that are transmitted to a display 49.

The analyzer 44 may have a plane structure similar to that of the polarizer 42. The retarder and the analyzer are coaxially arranged, along the axis or direction 48 of observation of the sample. In the case where the retarder includes two half wave plates (for the central wavelength of the incident flux) that are mutually orientable along this axis, the delay can be adjusted by varying this mutual orientation.

In order to enable the adjustment of the orientation of the analyzer and these two plates, these elements are rotatably mounted along an axis 48, and their rotation is carried out by a motor (respectively referenced 43a and 44a). These two motors are controlled by a control module 46 that can integrate a program that makes the sweep through the ranges of values of delay and orientation of the analyzer.

The module 46 may also include a memory for recording characteristics of the object, enabling modelling of the field scattered by the latter. This module can have an input 47 enabling it to receive at least a set point for the delay of the retarder and/or for the orientation of the analyzer, and can be coupled to the sensor 45 for an automatic processing of the data output from it.

The following description illustrates applications of this technique in more detail.

Lite Scatterings Case

We are concerned here with scattering of the light by surface roughness or volume heterogeneities, by dust or particles . . . . We are limited for this application to weakly disordered samples, thus giving rise to weak scatterings in the presence of the incident flux. It concerns for example surfaces having low slopes or low height, in the presence of the wavelength of the incident radiation, weakly heterogeneous volumes . . . . For these samples, we know that the far-field scattered fields are proportional to the Fourier transforms of the defects responsible for the scattering.

1 Cancellation of the Scattering Surface

For example, if h(r)=h(x, y) describes a surface profile, and if h (σ) is its Fourier transform of the spatial angular frequency σ, we will have:

A_{SS}(θ,φ)=C_{SS}(θ,φ)h(σ)A_{S}⁺ (13-a)

A_{SP}(θ,φ)=C_{SP}(θ,φ)h(σ)A_{S}⁺ (13-b)

A_{PP}(θ,φ)=C_{PP}(θ,φ)h(σ)A_{P}⁺ (13-c)

A_{PS}(θ,φ))=C_{PS}(θ,φ)h(σ)A_{P}⁺ (13-d)

With: σ=2π(n sin θ/λ) (cos φ, sin φ) (14)

And where the optical coefficients Cxy are independent of the microstructure of the scattering samples, in accordance with perturbative electromagnetic theories.

With this formulation, and because each polarization component of the field is proportional to the Fourier transform, this term h (a) may disappear when the cancellation condition is sought. One obtains in fact, from the relationship (7):

tgψ(θ,φ)=−exp [jΔη*(θ,φ)][C_{SS}(θ,φ)A_{S}⁺+C_{PS}(θ,φ)A_{P}⁺]/[C_{PP}(θ,φ)A_{P}⁺+C_{SP}(θ,φ)A_{S}⁺] (15)

Thus the position (ψ) of the analyzer, and the value of retarder (Δη*) no longer depend on the topography of the sample. In other words, and in accordance with the relationship (12), the cancellation complex _{ZO}, surf is the same for all weakly disordered surface topographies and for a given material. This coefficient can then be simply predicted by a first order approximation. With this approximation, the coefficients Cxy of the equations (13-a) (13-d) are slowly varying with the scattering direction, which correspondently simplifies the experimental setup.

2 Cancellation of Volume Scattering

What has been described for surface scattering applies equally to a volume scattering provided that random variations of the index of refraction are transverse. In this case, the angular scattering is proportional to the Fourier transform p(σ) of the function p(r)=Δε/ε that describes the relative transverse variations of the permittivity ε of the scattering medium. Consequently, the cancellation condition of the volume scattering, given by the complex _{ZO,VOI}, does not depend on the microstructure of the scattering volume. It is thus the same for all these volumes. The coefficients C_{XY} are also slowly varying.

3 Separation of Surface and Volume Scatterings

In general the interface complexes zo, surf and volume zo, vol complexes are different, so that it is possible to selectively cancel all the surface scattering or all the volume scattering. This makes it possible therefore to discriminate the effects of surface and of volume by a direct method. For example, one can finely observe scattering by a surface roughness after eliminating all volume scattering, or vice versa (FIG. 4).

The same method thus enables observation, with a heightened contrast, of the localized defects, after elimination of scatterings by the random components.

4 Imagery in Scattering Medium

To observe the light emitted by a component situated in a weakly scattering medium (FIG. 5), by positioning the analyzer and the retarder to cancel all scattering by the scattering medium, the contrast of the observation is increased and the parasitic light is thus eliminated. It is noted here that the surface scattering, the volume scattering, or the sum of these two scatterings, can be eliminated.

Heavy Scatterings Case

The previous description still applies, but the cancellation complexes z0, i.e. the value pairs corresponding to the position of the analyzer and the value of retarder, depend on the microstructure (topography or volume) of the objects examined. Rigorous electromagnetic models can be employed to predict the cancellation complexes, provided this microstructure has been previously measured and characterized. The cancellation condition may also be sought by means of a systematic exploration of the parameters ψ and Δη*, without any knowledge of the microstructure. Thus, one passes through the values zo that cancel the surface scattering, the volume scattering, or the sum of these scatterings.

In the case of an plate shaped object having two faces—or interfaces—bounding the volume of the plate, for these three elements (two interfaces and one volume), seven complexes _{Z0} are obtained, corresponding to seven value pairs of phase shift by the retarder and orientation of the analyzer, for which the detected flux is minimum, three value pairs corresponding respectively to these three elements, three other value pairs corresponding to the three possible combinations of two elements chosen among three elements. A seventh value pair corresponds to the combination of these three elements.

A major difference for these heavy scatterings is tied to the fact that the cancellation complexes _{Z0}(θ, φ) can vary strongly with the (θ, φ) direction of scattering (of observation). Depending on the solid angle of the detector, a polarization equivalent may also be defined and this method may also be applied for each solid angle. In all cases, being able to cancel the scattering by the scattering medium enables imaging and observation of the object of interest with a considerably increased contrast. If necessary, an image that was totally blurred, in the absence of the filter “g”, can be recovered.

1 Application to the Separation of Objects by Selective Imaging

We saw that an adjustable analyzer and an adjustable retarder can transform an electromagnetic field A, as follows:

A=>f(A)=cos ψ exp(jη_{S}*) [A_{S}+z.A_{P}]

where z is a complex number given by:

z=tg ψ exp(−j Δη*)

In addition, it is possible to choose the parameters (ψ, Δη*) to cancel the resulting field: ∃ _{Z0}(ψ, Δη*)/g(A=A_{X}+_{Z0} A_{P}=0

This cancellation condition is realized in a given direction of space, or a determined position. To realize this condition in all space, the complex _{Z0} must be systematically readjusted. The value of _{Z0} can then be calculated, or sought by an experimental exploration in (ψ, Δη*).

Considering two objects P1 and P2 emitting the polarized vectorial fields A1 and A2 when they are illuminated alone by means of a monochromatic polarized radiation, when these two objects are simultaneously illuminated by the same monochromatic radiation (FIG. 6), the resulting field A can be decomposed as:

A=A₁+A₂+A₁₂ (16)

Where A₁₂ describes the electromagnetic interaction between the two objects.

We now apply the transformation g carried out by the filter:

g(A)=(A_{1,S}+A_{2,S}+A_{12,S})+_{Z}(A_{1,P}+A_{2,P}+A_{12,P}) (17-a)

=>g(A)=g(A₁)+g(A₂)+g(A₁₂) (17-b)

Rather than seeking the complex _{Z0} enabling cancellation of g (A), we seek the complexes zi (iψ, Δηi*) enabling cancellation of each component separately, namely:

g_{Z1}(A₁)=A_{1,S}+_{Z1} A_{1,P}=0 (18-a)

g_{Z2}(A₂)=A_{2,S}+Z₂ A_{2,P}=0 (18-b)

g_{Z12}(A₁₂)=A_{12,S}+_{Z12} A_{12,P}=0 (18-c)

In the general case, the complexes zi are all different, and it is therefore possible to selectively cancel each of the components. In particular, one can recover information uniquely related to the field where, with the image Ai alone (FIG. 6), where it exclusively concerns the interaction A₁₂ between these 2 fields.

For this procedure to work simply, it suffices to know the value of the complexes zi. These can be given by calculation if the objects are known, and one is seeking to recognize them in a noisy environment for example. In the case where no object is known a priori, a systematic exploration of the complexes must be carried out. This method works for an arbitrary number of objects.

In this case, the received wave can be written:

A=Σᵢ₌₁ⁿAᵢ+A′=>g(A)=Σ Σᵢ₌₁ⁿ g(Aᵢ)+g(A′)

Where Aᵢ represents the image of the object Pi when it is illuminated alone and A′ the electromagnetic interaction between the n objects. Each term of the series given by the transformation g (A) can be cancelled.

2 Deep Analysis of Multiple Layers

The same technique can be extended to the deep analysis of multilayer objects or systems. FIG. 7 shows a multilayer system where one of the layers of the stack was arbitrarily chosen as a spacer or cavity.

The reflection factor of this system can be written in amplitude in the form of a series of elementary reflections:

r=r₀+t₀t′₀ ri exp(j2k)+t₀t′₀ r′₀ r1 exp(j4 _{K}) + (19)

=>r=r₀+t₀t′₀ r1 exp(j2K) [1/(1−r₀ r₁ exp(j2 k))] (20)

where _{K} is a dimensionless phase factor, characteristic of the thin layer and independent of the polarization:

k=(2π/λ) (necosi)ᵢ (21)

with (necosi)ᵢ the apparent optical thickness in the thin layer. In the relations (19-20), r₀ and t₀ represent the reflection and transmission factors of the higher sub-stack (0), while r1 is the reflection factor of the lower stack (1). For the retrograde waves (FIG. 8), t′₀ and r′₀ represent similar magnitudes.

The transformation g is applied to the reflected field, thus here to the reflection factor. The introduction of an analyzer and a retarder on the reflected beam leads to:

g_{Z}(Σᵢ rᵢ)=Σᵢr_{i,S}+z Σᵢ r_{i,P}=Σᵢ g_{Z}(rᵢ) (22)

where r_{S} and r_{P} are the reflection factors for each of the polarizations. This expression shows that the choice of the complex z enables arbitrary cancellation of any term of the series in (22):

g_{zj}(rⱼ)=0=>g_{zj}(r)=Σᵢ≠i g_{zi}(rᵢ) (23)

It was verified that the cancellation complexes are different for the different elementary reflections rᵢ, provided that they are placed in oblique illumination incidence.

If the expression (20) is now used, a first result is obtained as:

g(r)=g(r₀)+g(β) (24)

with: β=t₀t′₀ ri exp(j2_{K}) [1/(1−r′₀ ri exp(j2_{K}))](25)]

In this expression the factor r0 is only tied to the upper sub-stack, while the factor β involves the total stack (FIG. 9). These factors have different polarimetric responses, so that there is a cancellation complex Zc such as:

gzc(β)=0=>g(r)=g(r₀) (26)

In this case, the light collected by reflection is only from the upper part (30) of the stack, whatever the lower part (31).

Similarly, one can seek to keep only the second term of the equation (20):

g_{Z}[r−t₀t′₀ r₁ exp(j2_{K})]=0=>g_{Z}(r)=g_{Z} [t₀t′₀ ri exp(j2φ)] (27)

Under these conditions, the light reflected (FIG. 10) by the lower stack (31) can be isolated and collected.

More generally, and to the extent that the middle layer was chosen arbitrarily, the method applies to any layer of the stack, enabling free probing of it in elevation.

The analysis of a sample, whose geometry and optical properties are known or modeled, includes the following successive operations:

Selection of illumination angles of the sample by the source;

Adjustment of the orientation angle of the polarizer;

Modelling of surfaces or volumes of the sample;

Selection of angles of reception (θ, φ)

Selection of a wave or of a “packet” of waves to cancel;

Calculation of cancellation conditions (value of the delay and value of the orientation of the analyzer) starting from the model of the sample;

Control of the adjustment of the retarder and of the analyzer with the calculated values in preparation for obtaining the cancellation of the detected flux;

Acquisition of the principal desired flux and of the residual flux (residual parasitic).

In the case of a scene or sample having unknown structure or properties, the method can include the following successive operations:

Selection of the lighting;

Adjustment of the polarizer angle;

Selection of the reception angles;

Creation of a merit function;

Sweeping through the two parameters (phase shifter and analyzer) and seeking a minimum;

Selection of parameters leading to the minimum value; Acquisition.

The merit function in the case of examination of a blurred image can be the measure of the high frequencies of the image.

The different illumination and reception parameters can be chosen in order that the cancellation conditions of the undesirable flux is moved away from from the cancellation conditions of the useful flux.

1. A method of observation of an object along an arbitrary observation direction (θ, φ), the object having an interface or a volume, the method characterized in that:
a substantially monochromatic incident electromagnetic wave in the form of a polarized plane wave (E+) is directed toward the object,
an image of the object is captured using an imagery sensor, the image resulting from the electromagnetic wave (A(θ, φ)) specular, scattered or diffracted by an interface or a volume of the object illuminated by the incident wave in the observation direction (θ, φ),
a retarder having adjustable delay and an analyzer whose orientation is adjustable are successively arranged on the path of the wave (A (θ, φ)), between the an imagery sensor and the observed object,
the delay (Δη*(θ, φ)) of the retarder and the orientation (ψ(θ, φ)) of the analyzer are adjusted to minimize—even cancel—a part g (A) of the wave (A (θ, φ)) filtered by the retarder and the analyzer, and
imagery sensor output signals or image data are delivered.

2. A method according to claim 1 wherein the retarder includes a transparent medium (amorphous or crystalline solid or fluid) whose refractive index (and the resulting delay) is modified by application of an electric field, a magnetic field, or a mechanical stress.

3. A method according to claim 2 wherein the retarder includes a Pokels cell, a Kerr cell, or liquid crystals.

4. A method according to claim 1 wherein the retarder includes two parallel half-wave plates whose mutual orientation (and the resulting delay) is adjustable.

5. A method according to claim 1 wherein a value of the delay and a value of the orientation of the analyser, for which a part of the wave (A (θ, φ)) is minimized or cancelled, are estimated according to a model of the object.

6. A method according to claim 5 wherein the model of the object includes geometric data relating to interfaces and/or volume(s) of the object, the values of roughness of interfaces of the object, and values of refractive index of the media constituting and surrounding the object.

7. A method according to claim 1 wherein a range of values of delay is sweeped and for each value of this range a range of values of orientation is sweeped, and the intensity of the flux received by all or part of the imagery sensor for each value pair of delay and orientation, then a value pair of delay and orientation for which the flux is minimum or the contrast is maximum is determined.

8. A method according to claim 7 wherein a merit function such as a measure of the high-frequencies (spatial) of the image is used, to seek the value pair(s) of delay and orientation for which this function is maximum, with a maximum of high-frequencies corresponding to a minimum interference of the received flux and/or a maximum contrast of the image obtained.

9. A method according to claim 1 wherein the angles of incidence and the angle of polarization of the incident flux and the angles (θ, φ) of the observation direction are chosen so that the first values of delay and of orientation corresponding to the minimization of the first part of the wave (A (θ, φ)) are moved away from second values of delay and of orientation corresponding to the minimization of a second part of flux (A (θ, φ)).

10. A method according to claim 1 wherein the object includes a stack of thin layers and wherein an image of an interface separating two thin layers is captured.

11. A method according to claim 1 wherein the object is immersed in a scattering medium.

12. A method according to claim 1 wherein the central wavelength of the incident flux is situated in a range from 400 to 1100 nanometers.

13. A device useful for the implementation of a method according to claim 1, characterized in that it includes:
a substantially monochromatic light source and a polarizer arranged in order to direct an incident flux in the form of a polarized plane wave (E+) toward an object (40), the object having an interface or a volume,
an imagery a sensor sensitive to the luminous flux (A (θ, φ)) specular, scattered or diffracted by an interface or a volume of the object illuminated by the incident flux in an arbitrary observation direction (θ, φ), the imagery sensor delivering output signals or image data,
an adjustable retarder and adjustable analyzer successively arranged on the path of the flux (A (θ, φ)), between the sensor and object,
a control unit arranged to control a variation in the delay (Δη*(θ, φ)) produced by the retarder and to control a variation in the orientation (ψ (θ, φ)) of the analyzer and enabling minimization or cancellation of a part g (A) of the flux (A (θ, φ)).

14. A program including a code useable a computer apparatus for analysis of an object having at least a volume bounded by two interfaces, by the measurement of the electromagnetic flux (A (θ, φ)) specular, scattered, or diffracted by an interface or volume of the object illuminated by a polarized plane wave (E+), in an arbitrary observation direction (θ, φ), wherein the code enables control of an adjustable retarder and an adjustable analyzer arranged in this order on the path of the flux (A θ, φ)) between an imagery sensor, delivering output signals or image data, a sensor and the object, to enable minimization—even cancellation—of a part g (A) of the flux (A (θ, φ)) scattered, diffracted, reflected or transmitted by the object.

15. A program including a code useable by a processor of an observation apparatus for an object illuminated by a polarized plane wave, the object having an interface or a volume, the program characterized in that the code enables implementation of a method in accordance with claim 1.
